(19) United States
(12) Patent Application Publication
(10) Pub. No.: US 2007/0098925 A1
(43) Pub. Date: May 3, 2007

(54) Method for turf installation utilizing micromechanical bonding

(76) Inventor: Daniel A. Daluise, Southborough, MA (US)

Correspondence Address: PEARSON & PEARSON, LLP, 10 GEORGE STREET, LOWELL, MA, 01852, US

(21) Appl. No.: 11/589,025

(22) Filed: Oct. 27, 2006

Related U.S. Application Data
(63) Continuation-in-part of application No. 11/002,716, filed on Dec. 2, 2004, now Pat. No. 7,128,497.
Application No. 11/002,716 is a continuation-in-part of application No. 10/869,063, filed on Jun. 17, 2004, now abandoned.
(60) Provisional application No. 60/526,371, filed on Dec. 2, 2003.
(60) Provisional application No. 60/567,085, filed on Apr. 30, 2004.
(60) Provisional application No. 60/520,185, filed on Nov. 15, 2003.

(51) Int. Cl. A41G 1/00; B32B 37/00; B32B 37/12; B29C 65/00

(52) U.S. Cl. 428/17; 156/71; 156/304.3; 156/304.4

(57) ABSTRACT

A method for artificial turf installation utilizing micromechanical bonding for seaming between adjacent pieces of the artificial turf. The artificial turf comprises a backing which includes primary, secondary, and tertiary backing materials. The tertiary backing comprises a foam urethane lamination of an additional textile layer for attaching to the secondary backing (coating), and the tertiary backing is suitable for receiving hooks of a hook seaming tape which is positioned under the seam area of two adjacent pieces of artificial turf. After proper positioning of the two adjacent artificial turf pieces, micromechanical bonding is accomplished. An alternate embodiment of the method comprises the step of using pressure-sensitive seaming tape to bond to the tertiary backing of the artificial turf.

### CROSS-REFERENCE TO RELATED APPLICATIONS

This application is a Continuation-in-Part (CIP) of application Ser. No. 11/002,716, filed Dec. 2, 2004, now U.S. Pat. No. ______, which is a Continuation-in-Part of Application No. 10/869,063 filed Jun. 17, 2004, which claims the benefit of U.S. Provisional Application No. 60/520,185, filed Nov. 15, 2003, and CIP Application No. 11/002,716 also claims the benefit of U.S. Provisional Application No. 60/567,085, filed Apr. 30, 2004 and U.S. Provisional Application No. 60/526,371, filed Dec. 2, 2003, all of which are incorporated by reference herein in their entirety.

### BACKGROUND OF THE INVENTION

1. Field of the Invention

The present general incentive concept relates to artificial playing surfaces for athletic games. More particularly, the present general incentive concept relates to horizontally and/or vertically draining water from artificial turf. Further, the invention relates to an apparatus and method for bonding together sections of artificial turf and in particular, a micromechanical bonding of the seams using hook seaming tape or pressure-sensitive seaming tape.

2. Description of Related Art

Vertically draining artificial turfs, commonly called “infilled turf”, and as embodied in U.S. Pat. Nos. 4,337,283 and 5,976,645 and others, represent a great improvement over the original short-pile artificial playing surfaces in that they reduce abrasiveness, increase shock attenuation, improve response to foot and ball actions, and have an improved appearance.

Because these turf systems drain vertically, it was necessary to construct a vertically draining stone base, which could infiltrate water from the surface at a rate greater than the rainfall rate expected in a large rainstorm. To accomplish this, it was necessary to build the base with a high infiltration rate. However, such base was less stable, especially with regard to maintaining the high tolerance finish grade, throughout the life of the turf. As a result, either the infiltration rate or stability of the stone base was composed.

For those reasons, there is a need for constructing artificial turfs that allow rainwater to evacuate at sufficiently large capacity without compromising the structure of the base.

The advantages of the artificial turf systems have contributed to the increasing use of replicated grass surfaces as a solution to sports surfacing problems, resulting in a great number of annual installations in the United States. Unfortunately, the pool of mechanics with the required skills and abilities to properly install turf systems is limited. As a result, many installations fail to meet the minimum quality standard. Improper installation also portends increased warranty liability in the future.

According to the prior art technology, a large piece of artificial turf must be built using two or more pieces of synthetic turfs, which are normally provided in 12 or 15 foot wide rolls (of varying length). It is, therefore, generally necessary to connect any two neighboring pieces of synthetic turfs either by sewing them together or by bonding them using an adhesive and seam-tape. Sewing is generally effective, but is labor-intensive. Moreover, sewing requires a skill that is in limited supply in the artificial turf industry, and most importantly, cannot be used to connect turf with dimensionally stable high-quality backings, which are too strong and too thick to allow a sewing needle to pass. Bonding by an adhesive and seam-tape requires an even higher level of skill and expensive bonding agent. Moreover, this method is inconvenient because it cannot be performed in cold or wet weather. Both methods have the disadvantages of inflexibility in that once a seam is formed, it cannot be adjusted.

In the past, mechanical seaming (Velcro®) has been used in essentially portable carpet-type (with no infill) artificial turf. In this case, a “loop” sheet material of 6-12 inch width was sewn to the backing of the carpet, along its long length. The “hook” sheet material, generally 8-12 inches wide, was placed on the sub-surface of the carpet along the edge for forming the seam.

This system of seaming carried a number of disadvantages. The multiple layers of bonding materials tended to create a deviation in the surface plane, which was both visible and noticeable by feel. In outdoor use, the difference in the coefficient of thermal expansion between the sewn-on loop material and the turf backing could cause puckering problems. Alignment and trimming of the mechanical bonding materials and turf materials could also be extremely difficult during installation.

Also, the sewing of the loop material to the turf backing was difficult and time-consuming.

### SUMMARY OF THE INVENTION

It is an aspect of the present general inventive concept to provide an artificial turf, which allows rainwater to evacuate efficiently without infiltrating its stone base, thereby increasing the stability of the base.

Another aspect of the present general incentive concept is to provide an artificial turf that is easy to maintain, thereby reducing the maintenance costs. Yet another aspect of the present general incentive concept is to provide a method for constructing artificial turf that has a horizontally draining system.

The above aspects can be obtained by an apparatus that includes (a) a sloped blanket beneath a horizontal permeable turf layer to direct water; and (b) a main drainage system to collect the water directed from the sloped blanket.

The above aspects can also be obtained by an apparatus that includes (a) a core made of water-resistant material; (b) a top layer made of permeable materials; and (c) expansion joints located throughout the blanket.

The artificial turf system of the present general inventive concept comprises a base made of cementations or limestone derivatives or soil aggregates, a permeable or perforated artificial turf at top, and an impermeable drainage blanket between the base and the artificial turf. The turf is constructed with a sufficient slope, and at least one of lower edges of the artificial turf is connected to or close to a perforated pipe in connection with a main drainage system. Therefore, the rainwater first drains vertically from the artificial turf to reach the drainage blanket, and then drains horizontally along the drainage blanket to reach the perforated pipe and the main drainage.

The drainage blanket is a piece of solid slab containing sufficiently large and properly distributed continuous void, allowing water to flow in at least one direction. Alternatively, it may consist of a rigid solid cupsated core, covered by one or more water impermeable sheets. To build a large artificial playing field, two or more pieces of drainage blankets may be jointed by a watertight seam so that water cannot pass through the joint to reach the base. In this way, a monolithic full area impermeable drainage blanket is created.

The present inventive concept provides a method for quickly and economically constructing an artificial turf playing field, which has reduced engineering risks and increased water evacuation capacities. The method id especially useful when poor soils or unfavorable site drainage conditions are encountered. In addition, a method is provided for determining the necessary water-evacuating capacity for a given artificial turf system, therefore reducing engineering risks.

The artificial turf system of the present general inventive concept has one or more of the advantages. In one aspect, rainwater does not get into the base of the invented artificial turf system, and therefore, the infiltration property of the base is no longer necessary provided that the entire drainage blanket has been designed with a sufficient flow capacity to provide the required evacuation rate. In another aspect, when an impermeable drainage blanket is used, the base is better protected and its insulation life is extended.

In yet another aspect, the drainage blanket under the artificial turf system may act as an excellent shock attenuation pad. By designing the structure of the drainage blanket, different degrees of the shock attenuation may be achieved. Finally, when the base is constructed by missing onsite soils with a soil stabilizer to form a strong, durable and water-impervious base, it is unnecessary to excavate, export or import soils to or from the sire, thereby reducing construction costs and time, Incorporation of the soil stabilizer in the base also increases the stability of the base and the playing field.

Further, the present invention solves the problems associated with the prior art seaming methods by integrating the backing with a mechanical-bonding layer. The present invention incorporates a layer of tertiary backing to a secondary backing. This tertiary backing consists of a foam urethane lamination of an additional textile layer to the secondary backing. This serves as the loop material. A bonding seam can be formed by placing a hook seaming tape right below the joint seam of two pieces of artificial turf, which incorporate this loop material backing.

The advantage of this new method is to eliminate sewing and greatly reduce or eliminate gluing. Because the seams are initially bonded only by mechanical means, they may be adjusted for perfect alignment, thereby reducing the necessary skills of the installing mechanic. The virtual elimination of adhesive materials also greatly reduces installation cost and time. Future repair, replacement, addition or change, are greatly simplified.

Another advantage of this tertiary backing construction is a significant increase in dimensional stability, especially climatic dimensional stability; improved tuft-bind; a reduction in “wrinkling” of the turf as delivered, and an increase in total weight of the product.

This tertiary backing comprises one of a cold urethane or a hot-melt lamination of an additional textile layer to the secondary backing. This serves as a full-area loop material which incorporates this loop material backing, in the alternative, a climatically stable pressure-sensitive tape may be utilized to bond to the tertiary backing.

Those and other aspects of the present general inventive concept will become apparent to those skilled in the art after reading the following detailed description of the general inventive concept together with the following drawings.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a cross-sectional view of the structure of the vertically draining artificial turf system, according to an embodiment;

FIG. 2 is a cross-sectional view of the conventional artificial turf, according to an embodiment;

FIG. 3 is a cross-sectional view of improved artificial turf containing straight and curled yarns in an alternative stitch line configuration, according to an embodiment.

FIG. 4 is a perspective view of the drainage blanket made of a single piece of material, according to an embodiment;

FIG. 5A is an open view of the composite drainage blanket after the top sheet is removed, according to an embodiment;

FIG. 5B is the cross-sectional view of the composite blanket of FIG. 5A along line 5-5, according to an embodiment;

FIG. 6A, 6B and 6C shows the cross-sectional views of several versions of the composite blanket (all views are taken at the cross-sectional along line 6-6 of the drainage blanket of FIG. 5A, according to an embodiment; and

FIG. 7 is a cross sectional view of the vertically draining artificial turf system containing collocated perforated pipes, according to an embodiment.

FIG. 8 is an exploded cross-sectional view of a micromechanical bonding of two adjacent pieces of artificial turf using a polymeric hook seaming tape which attaches to a tertiary backing of the artificial turf according to the present invention.

FIG. 9 is an exploded cross-sectional view of an alternate method for micromechanical bonding of two adjacent pieces of artificial turf using a pressure sensitive tape which attaches to a tertiary backing of the artificial turf according to the present invention.

### DESCRIPTION OF ILLUSTRATIVE EMBODIMENTS

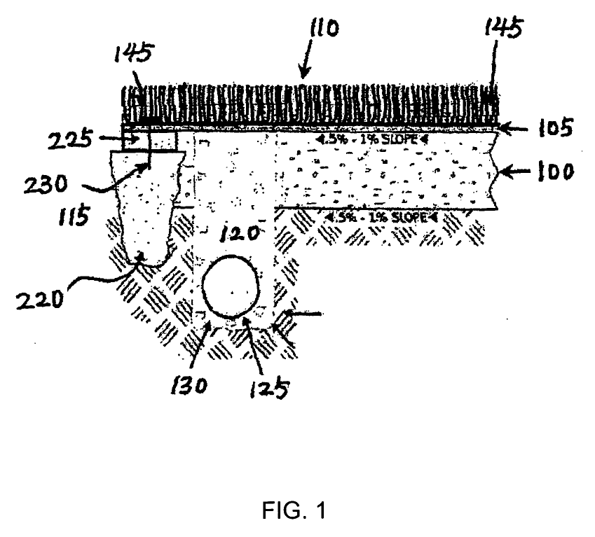

FIG. 1 is a cross-sectional view of the structure of the vertically draining artificial turf system, according to an embodiment.

In an embodiment of the present general inventive concept, the horizontally draining artificial turf system can include a base 100 built with an sufficient degree of slope, a drainage blanket 105 above the base 100, an artificial turf 110 over the drainage blanket 105, fastening mechanism 115 to attach the artificial turf 110 onto the base 100, and a draining apparatus 120, which is situated near and below the lower edge of the base 100. The artificial turf is 110 is water permeable or perforated, allowing water to drain vertically to reach the drainage blanket 105. The draining apparatus 120, consisting of a perforated pipe 125 and surrounding washing sands or stones 130, is directly under the opening or perforated edge of the drainage blanket 105 near the lower edge of the base 100 so that the water from the drainage blanket 105 is able to slow into the perforated pipe 125 to reach the main drainage system (not shown). Where the base (or portions of the base) is supposed to allow water to pass, these portions can be made of a water permeable material. This can be an aggregate material, such as stone, rocks, a combination of stones and rocks, sand, permeable concrete, as well as existing drainage systems.

The artificial turf 110 can be conventional artificial turf or an improved artificial turf. The main drainage system can be located in a center (and below) the turf, or on a perimeter of the turf (on either, some, or all sides of the field or extending beyond the field). Thus, the drainage blanket 105 can be sloped towards the center of the field, in which water flows to a center (and thereafter below) the turf, or the drainage blanket 105 can be sloped away from the center of the field, and thus water flows towards to perimeter (and perhaps beyond) of the field.

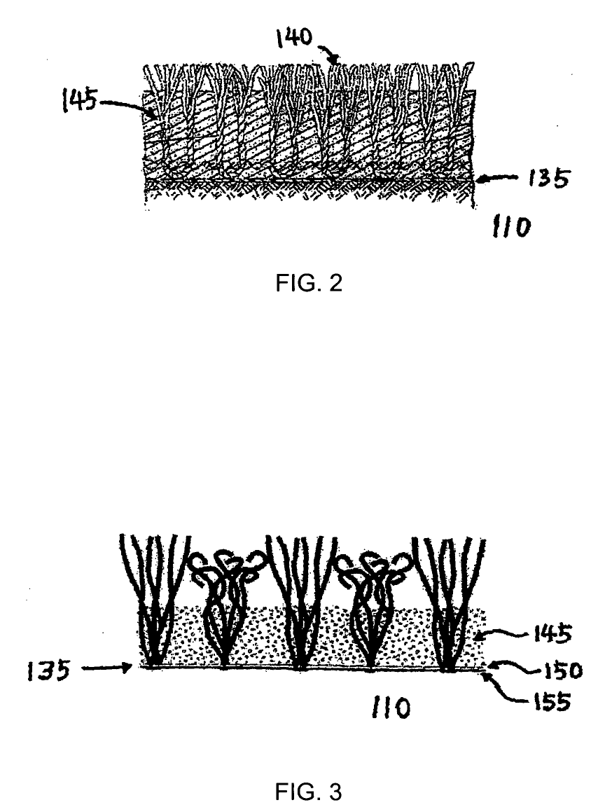

FIG. 2 is a cross-sectional view of the conventional artificial turf, according to an embodiment.

A conventional artificial turf can include a backing 135 made of a woven or non-woven sheet material, a pile fabric 140 tufted in the backing 135, and, optionally, an infill 145 which is a resilient granular material. To make the pile fabric 140, yarns of single or plural fiber filaments are looped into and back out the backing 135 and are cut to the same length as shown in FIG.2.

FIG.3 is a cross-sectional view of improved artificial turf containing straight and curled yarns in an alternative stitch line configuration, according to an embodiment.

An improved artificial turf can include a backing 135, a pile fabric 140, and optionally an infill 145 in the space between the filaments of the pile fabrics 140. The pile fabric 140 comprises curled and straight yarns tufted in the backing 135 in alternative stitch lines.

The backing 135 consists of a primary backing 150 and a secondary backing 155, and is sufficiently permeable, or has plural holes (now shown) if it is made of an impermeable material to allow water to pass onto the drainage blanket 105. The primary backing 150 may be made one of to three layers of woven and/or non-woven fabrics. Generally, these fabrics are polypropylene, polyester or other synthetic materials. While two-layer backing is feasible, the preferred construction is three layers with the outside layers comprised of a woven, fibrated (fleeced) material known in the trade as “FLW”, and the center layer comprised of a dimensionally stabilizing woven or non-woven material. A dimensionally stabilizing material can be any material suitable for this purpose, such as a synthetic fabric material (e.g. polyester), or any other known material used for this purpose. The total weight of the backing 135, before coating, can vary between 3 ounces per square yard and 12 ounces per square yard, with the preferred total primary backing weight at 10 ounces per square yard. The secondary backing 155 is a polymeric coating, which is applied to the primary backing and heat-cured. The polymeric coating is usually latex or urethane, with urethane being preferred type. The coating weight varies between approximate 12 ounces per square yard and approximate 30 ounces per square yard, with 28 ounces per square yard of urethane being the preferred weight.

The infill 145 is comprised of resilient particles or a mixture of from 25 to 95 volume percent resilient particles and from 5 to 75 volume percent fine sand inter-spread among the filaments of the pile fabric 140 and on the backing 135 to a substantially uniform depth, with the preferred infill comprises of 100% rubber granules. The infill 145 may optionally comprises up to 20 volume percent of a moisture modifier such as vermiculite and calcined clay.

The depth of the infill 145 is between about ¾ inches and about 2.75 inches, with the preferred depth at about 1.0 inch. The height of the yarns above the infill 145 is between about ½ inches and about ¾ inches, with preferred height of yarn about the infill 145 about 1.0 inch.

The drainage blanket 105 in its simplest form is a water impermeable sheet. When this structure is used, water flows along the backing 135 of the artificial turf 110 horizontally. Two sides sheets, which are extended from the same sheet of the drainage blanket or made of other materials, are necessary to prevent water from flowing on to the base 100. This design may be useful in geographic locations where rainfall is scarce. High-density and water previous infill materials such as washing sands or heavy rubbers granules should be used to reduce the chance that the infill 145 “floats out” in unexpected large rain.

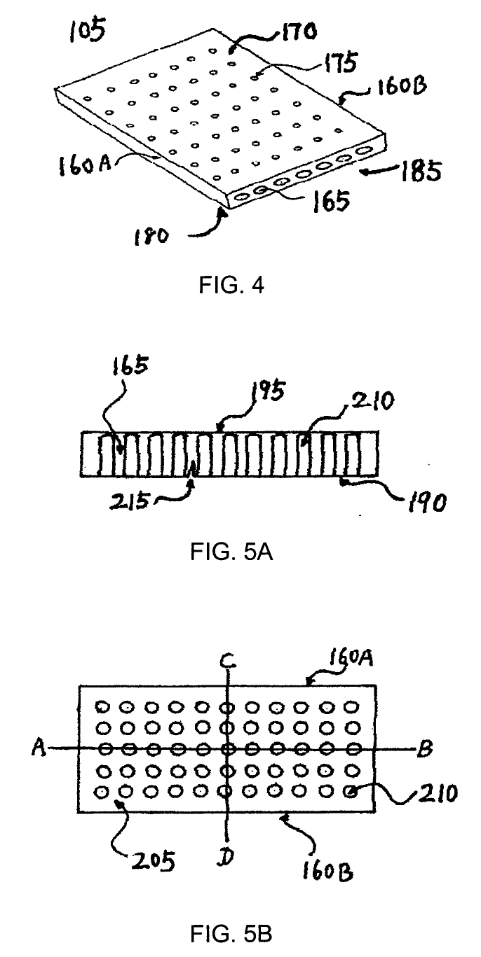

FIG. 4 is a perspective view of the drainage blanket made of a single piece of material, according to an embodiment.

The drainage blanket 105 may be permeable or perforated where the base 100 remain porous or pervious. This may be desirable, for instance, then it is required that Q-values or run-off rates do not exceed existing conditions prior to construction.

The drainage blanket 105 may be made of one single piece, like a flat slab containing continuous void, which allows water to flow in at least one direction. In this case, the side sheets 160A and 160 B of the members of the slab. The void within the entire slab must be continuous and sufficiently large so the drainage blanket 105 has a suitable water evacuation capacity. One example is a slab containing plural substantially parallel cylindrical, cubic or rectangular recesses 165. The top member of 170 of the drainage blanket 105 contains a plurality of properly distributes receiving holes 175 of suitable size for receiving water from the artificial turf 100. The structure allows the water to flow along the direction of the recesses 165. To allow water to flow cross individual recesses, it is necessary to remove some joint walls between individual recesses or to create a second set of cylindrical, cubic or rectangular recesses (not shown), perpendicular to the first set of the recesses 165.

The bottom member 180 of the drainage blanket 105 is waterproof. The drainage blanket 105 is molded as a single piece from one or more materials. The bottom member 180 of the drainage blanket 105 may have more some properly distributed discharging holes, which might be used in some situations where the base 100 is pervious. At least one end of the drainage blanket 105 has plural exit openings 185, which allow water to discharge into the draining apparatus 120 in the field. The discharging holes may be perforated in the blanket 105 after the blanket is already molded. In other words, the holes can be punched in after manufacture of the blanket.

Note that depending upon the embodiment, the drainage blanket 105 can be impermeable, have vertical openings to only direct water vertically, can have horizontal openings to only direct water horizontally, or can have both horizontal and vertical openings to discharge water both vertically (e.g. out the bottom) and horizontally (e.g. out the side). The drainage blanket 105 may be made of many pieces of same or different materials (a composite drainage blank).

FIG. 5A is an open view of the composite drainage blanket after the tope sheet is removed, according to an embodiment. FIG. 5B is the cross-sectional view of the composite blanket of FIG. 5A alone line 5-5, according to an embodiment.

The drainage blanket 105 is made of a core 190, a top sheet 195, two side sheets 160A and 160B, and, optionally, a bottom sheet 200 (FIG.5). The core 190 may be molded, as one single cupsates structure, using a strong, durable, and water resistant material such as a high-density polyethylene. The core 190 generally has a core base 205 and a plurality of inversed cup-like studs 210 extended from the core base 205. The size, height, density (the number of studs in a unit area) of the studs 210 and their arrangement on the core base 205 depend upon the material used, the intended use of the playing field, desired shock attenuation effects, and expected the maximum rainfall intensity in the location. The studs 210 might be hollow (like inversed cups) or complete solid. The structure, density (number per unit area), arrangement, and material of the studs 210 affect the shock attenuation property.

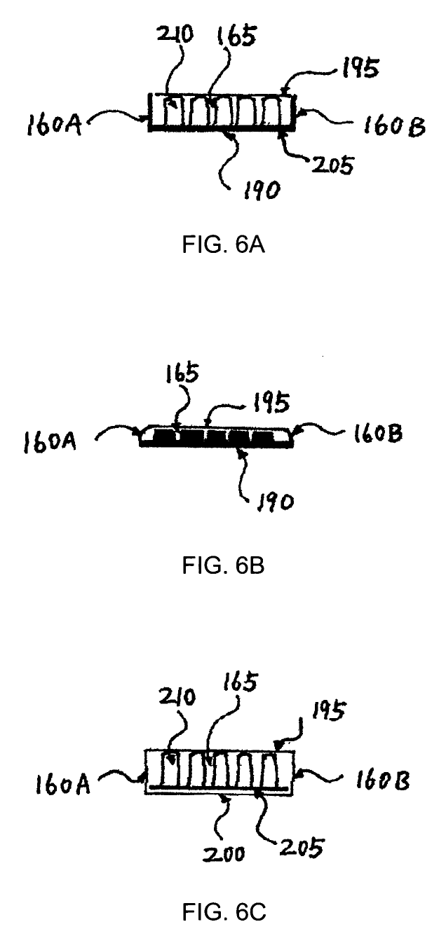

FIG. 6A, 6B, and 6C show the cross-sectional views of several versions of the composite blanket of FIG. 5A (all views are taken at the cross-sectional along line 6-6 of the drainage blanket), according to an embodiment.

A variety of methods may be used to put those components together build the drainage blanket 105. The top sheet 195 should be permeable or perforated so that it can allow water from the artificial turf 110 to pass. The side sheets 160A and 160B should be substantially waterproof. The bottom sheet 200 should be watertight unless it is desirable to allow water to drain vertically in a limited capacity to suit special needs. The top sheet 195, in one example, can be a sheet made of permeable woven material such as geotextile materials. The side sheets 160A and 160 B, which join the core base 205, prevent water from getting onto the base 100 (see FIG. 6A).

In another example, the side sheets 160A and 160B may be the extended members of the core 190 and are close to or join the top sheet 195. In a further example, the top sheet 195 and the side sheets 160A and 160B may be made of one single continuous sheet joining the two sides of the core base 205 (see FIG. 6B). In this case, if the sheet is impermeable, the portion of the sheet serving as the tope sheet 195 should be perforated. Finally, one single continuous sheet may be used to serve as the top sheet 195, the side sheets 160A and 160B, and the bottom sheet 200, wrapping around the core 190 (see FIG. 6C). OF the sheet is impermeable, it is necessary to perforate the portion of the sheet at top. In all examples, adequate perforation may be achieved by punching a plurality of properly distributed holes of suitable size in the sheet. The perforation area per unit must be sufficiently large to drain the water from the heaviest rainfall expected in the installation location.

The drainage blanket 105 may consist of a high-density polyethylene (HDPE) core of fused, entangled filaments sandwiches between a needle punches non-woven geotextile on one side and a head-bonded non-woven geotextile on the other side.

The drainage blanket 105 should be of sufficient compressive strength (minimum 30,000 PSF) to support construction equipment used if heavy construction equipment is used during turf installation.

Optionally, the core base 205 may have plural properly distributed holes (not shown), allowing for desirable vertical drainage. If the bottom sheet 200 is used and is impermeable, it may also have plural holes (not shown) allowing water to drain vertically. If the bottom sheet 200 is dispensed with, it is necessary for the core 190 to have two the side sheets 160A and 160B along the direction of intended water flow to prevent water from getting onto the base 100.

The drainage capacity has been tested for ProDrain™ dynamic drainage blanket using 20.00 pound per square foot overburden pressure and a gradient of 1.0%. The maximum discharge capacity was found to be 2.18 gallons per minute and a per foot or 0.291 cubic feet per minute and per foot. Assuming that water travel to a drainage system is 90.00 feet, this blanket can evacuate the rainwater from steady rainfall of 2.33 inches per hour. Applying the reduction factor pf 0.5 for considering the horizontal surface flow, the blanket can evacuate the rainwater from a steady rainfall of 4.66 inches per hour. Applying a safety factor of 1.05, the estimated final capacity is therefore 4.44 inches per hour.

The drainage blanket 105 of the type described tends to expand and contract with temperature changes. Thermal expansion can deform or distort the drainage blanket 105, creating a wave-like structure. As the blanket lies just beneath the artificial turf 110, the deformed or distorted drainage blanket will impact the artificial turf 110 a wave-like unnatural look. Therefore, it is necessary to incorporate expansion joints 215 in the drainage blanket 105. If the drainage blanket 105 is made of a single piece, the expansion joints 215 are plural small slits, which may be bridged by a flexible watertight tape (not shown). The joint slits are substantially evenly distributed along the drainage blanket 105. Alternatively, the expansion joints 215 may be just molding-in inversed “V” or accordions joints at the top member 170 and the bottom member 180 at suitable intervals. Because the expansion joints 215 run in the direction perpendicular to one of the main axis of the track of the artificial turf 110, the studs 210 should not be allocated along the like where the expansion joints 215 are placed. When the drainage blanket 105 on two sides of each of the expansions joints 215 will move closer to each other, without deforming the drainage blanket 105. The inversed “V” joints are designed so that their apex will not infringe the member close to the apex at expected the highest temperature.

If the drainage blanket 105 is made of composite materials and its top is a sheet of woven materials, the expansion joints 215 are provided in the core base 205 only. In this embodiment, the expansion joints 215 are just plural small slits in the core base 205 at proper intervals. The slits may be bridged by a flexible waterproof tape. Alternatively, the expansion joints 215 may be just molding-on inversed “V” or accordions joints at the core base 205 at proper intervals. Because the expansion joints 215 run in the direction perpendicular to the one of the main axis of the track of the artificial turf 110, the studs 210 should not be allocated along the line where the expansion joints 215 are situated.

The width and frequency of the slits along the main axis of the track of the artificial turf depends upon thermal expansion coefficients of the materials and anticipated changes in the field temperature in the location. If the material of the top and bottom members of the core base 205 expands to a great degree upon a rising temperature, broader slits and more slits are needed for given track of the artificial turf 110. Likewise, when V-joints of large size are necessary to compensate the thermal expansion effect.

The drainage apparatus 120 may be of any type that is used in prior art. There are several ways to construct the draining apparatus 120. In one of the preferred embodiments (FIG.1), the draining apparatus 120 is a perforated pipe 125 that is laid underground near the lower edge of the base 100 and is surrounded by the washing sands or stones 120. The perforated pipe 125 is placed with required slope with its lower end connected to the main drainage system (not shown). The washing sands or stones 130 are necessary to support the drainage blanket 105 and the artificial turf 110 and also provide necessary permeability for transporting water.

In a further embodiment a plurality of the perforated pipes can be arranges vertically and can be surrounded by the washing sands or stones.

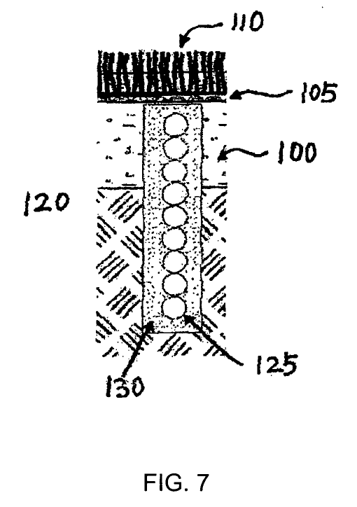

FIG. 7 is a cross-sectional view of the vertically draining artificial turf system containing collocated perforated pipes, according to an embodiment.

Perforated pipes 125 can be arranged vertically and operate in unison. For example, water can collect in a bottom pipe of the perforated pipes 125, but if the water exceeds the capacity of the bottom pipe, the water can then flow in the higher pipe, and so on. The vertical pipes contain an opening on the top and bottom (except for the bottom pipe which is sealed on the bottom).

To prevent water from leaking into the base 100, the draining apparatus 120 may be insulted by water impermeable materials. The perforated pipes 125 should have sufficient size for adequate drainage rate.

The base 100 of the artificial playing filed may be a flat layer of slab made of stone, stone aggregates, cementatious materials, limestone derivatives, or any other suitable materials. The thickness of the slab depends upon materials and structures of the base 100 and the intended use of the playing field. In addition, the base 100 may be constructed by mixing on-site soils with a soil stabilizer. A suitable soil stabilizer, for example, is polymer-enzyme solid stabilizer manufactured by G.M. Boston Co., Newport Beach, Calif. The thickness of the base 100 is in the range from about 1.0 inch to about 10 inches, with a preferred thickness in the range of 2.0-4.0 inches. The base 100 is constructed with its top surface having a slope sufficient for drainage, preferably in the range of 0.5%-1.0%, along the direction of intended water flow.

While this vertical to horizontal draining system of the present general inventive concept can be constructed over any compacted and stable materials, there is often an engineering concern for the stability of the aggregate base, should it become saturated and/or subject to high compressive forces such as from construction equipment or vehicles.

The method of constructing the base 100 using onside solids includes steps of mixing onsite soil with a soil-stabilizer, ripping, applying the mixture on the site, and grading the surface. For example, a suitable soil stabilizer if ProX300 or polymer-enzyme solid stabilizer manufactured by G.M. Boston Co., Newport Beach, Calif. When a right stabilizer is properly infused with the soils, the base 100 is virtually impervious, with a sufficiently high compressive strength, preferably, in excess of 400 PSI.

The fastening mechanism 115 for anchoring the artificial turf 110 onto the playing field consists of a concrete footer 220 which protruded into the ground, a poly-board mailer 225 firmly attached to the concrete footer 220, and a plurality or ramset nails 230, which are driven into the concrete footer 220 from the artificial turf 110 (see FIG. 1). In one of the preferred embodiments, the concrete footer 220 has a shape of 6×16 inches cylinder. IN may be rectangular stud or a wall-like structure, which is formed by poring properly prepared concrete paste to the hole in the ground. The concrete footer 220 should have sufficient depth, preferably 10 to 20 inches. When the concrete footer 220 is a wall-like structure, the poly-board nailer 225 may be strip installed over the top surface of the concrete footer 220. When the artificial turf 110 is filled with a resilient infill material. The metal heads of the ramset nails 230 are completely covered up. The fastening mechanism 115 may be used anywhere around the artificial turf 110 so that the artificial turf 110 will be sufficiently stable horizontally. If the base 100 is a concrete slate, part of the base 100 may serve as the footer.

The horizontally draining artificial turf system may be constructed in-house playing fiend, typical outside athletic field, stadium, or other suitable locations.

### Method for Micromechanical Bonding Adjacent Pieces of Artificial Turf

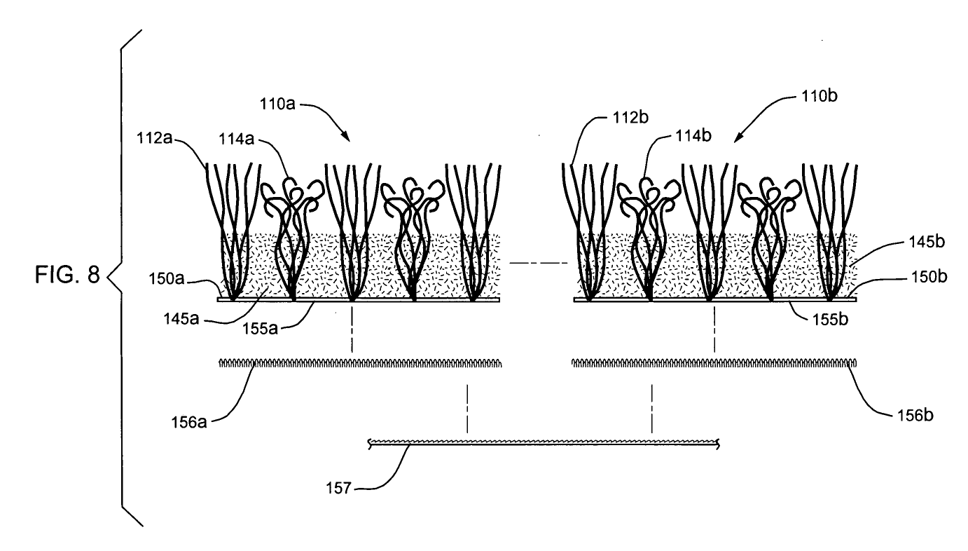

Referring to FIG. 8, an exploded cross section of two pieces 110a and 110b of artificial turf are illustrated showing a primary backing 150a, 150b, a secondary backing 155a, 155b, and a tertiary backing 156a, 156b of the artificial turf, and two pieces 110a, 110b of the artificial turf are attached adjacent to each other using a polymeric hook seaming tape 157 which mechanically attaches to the tertiary backings 156a, 156b of a portion of each piece 110a, 110b of the artificial turf. Each piece 110a and 110b of artificial turf comprises straight yarns 112a, 112b and curled yarns 114a, 114b, but the type or size of yarns does not matter. The artificial turf may comprise all straight yarns or all curly yarns or any combination.

The tertiary backing 156a, 156b is laminated to the secondary backing 155a, 155b which comprises a polymeric coating applied to the primary backing 150a, 150b and heat cured, and the tertiary backing 156a, 156b comprises a cold urethane lamination or a hot-melt lamination of an additional textile layer to the secondary backing (coating) 155a, 155b. The urethane lamination process is similar to that provided by Universal Textile Technologies of Dalton, Ga., and the hot melt process is similar to that provided by Nexcel Synthetics/EZ Bac, (formerly Barrierbac) of Calhoun, Ga. This construction provides for the lamination of a final exposed fabric bottom of the tertiary backing 156a, 156b, which serves as a full-area “loop”, open weave, or nonwoven, interface for the artificial turf mechanical bonding system as shown in FIG. 8.

A polymeric tape 157 of the “hook” material manufactured by Velcro Corporation of Manchester, N.H. is placed on a subsurface in the same manner as ordinary seaming tape would be placed on the subsurface for an adhesive bonding system known to one of ordinary skill in the art. The hook seaming tape 157 may be from 2 to 30 inches wide, with the preferred width being about 13 inches. The tape 157 can be produced from various resins, with HDPE being the preferred resin. The height, shape and density of hooks on the tape 157 can also vary greatly, and the preferred configuration is determined by the nature of the “loop” material chosen for the tertiary backing 156a, 156b. Preferably, the hook seaming tape 157 is covered with a quick-release membrane (not shown) lightly bonded to the hooks. This allows for easy movement of the tertiary backing 156a, 156b or loop-backing over the hook seaming tape 157 without mechanical engagement until the membrane is removed. If a quick-release membrane is not provided, the hook seaming tape can be covered with any of suitable materials such as polyethylene sheets to prevent premature or unintended mechanical engagement.

Because the loop material is on the entire area of the exposed fabric of the tertiary backing 156a, 156b, it is not necessary to sew or glue loop material to the tertiary backing 156a, 156b during turf installation. Furthermore, the artificial turf pieces 110a, 110b can be trimmed in any manner and for any locations without the need for concerning the presence of loop material.

During a typical turf installation, the two pieces of turf, often from two rolls of turf, are butted together with the loop tertiary backing 156a, 156b being placed over the hook seaming tape 157. After the rolls or pieces 110a, 110b of turf are properly aligned, the quick-release membrane or other release paper, if it is present, is removed. The loop tertiary backing 156a, 156b of the turf is then pressed against the hook seaming tape 157 with pressure (standard rolling procedures are preferred, but any weight, including foot pressure, will be sufficient).

If the seam produced in installation is deficient in placement or function, the two pieces of turf can be easily separated by vertical force, re-engaged with a more precise alignment, and pressed together with a suitable force. The steps of this method may be repeated until a satisfactory positioning and good alignment are achieved.

If no adhesive is applied, and all adjustments have been made to a user's satisfaction, an infill may then be interspersed into the grass-resembling filaments. This infill will serve to prevent the edge of the primary layer or backing 150a, 150b of the turf from being dislodged by the normal foot-action during use in the absence of adhesive bond.

By avoiding using an adhesive on the seam, the surface may be easily “un-seamed” for repair, replacement or adjustment. The turf system is portable because it is easy to disengage the connected pieces, roll-up each piece for transportation, and re-install them in a different location.

To provide additional assurance of the performance of such hook type mechanical bonding, a bead of adhesive (not shown) may be applied to the seam line, which is typically approximately 1-40 mm or more in width between the two abutting pieces 110a, 110b of turf. The adhesive along the seam line will increase the resistance of the mechanical bond to vandalism and its resistance to vertical or “peeling” force encountered in normal use. Of course, using the adhesive will reduce the portability, easiness of repair or adjustability of the turf.

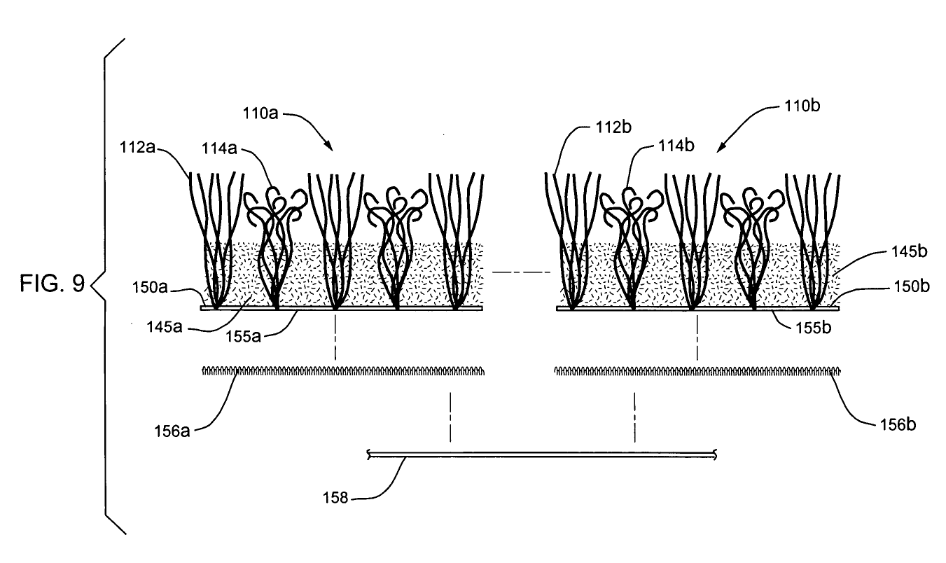

Referring now to FIG. 9, FIG. 9 is an exploded cross-sectional view of an alternate method of micromechanical bonding of two adjacent pieces 110a, 110b of artificial turf using a pressure sensitive seaming tape 158 which attaches to the tertiary backing 156A, 156b of the artificial turf according to the present invention.

A climatically stable pressure-sensitive (P-S) tape may be embodied by a TPO tape manufactured by Carlisle Syntec Incorporated of Carlisle, Pa. to replace the hook seaming tape 157. The pressure-sensitive tape 158 may be used in widths between 1 inch and two feet, but ideally a width between 6 inches and 1 foot is utilized. It is important that the P-S tape 158 exhibits a long-term resistance to thermal expansion and contraction due to climatic temperature and humidity differentials, as well as long-term durability with regard to thermal and moisture stresses.

The installation and post-installation procedures for the P-S tape 158 are essentially the same as previously described for the hoop seaming tape 157, including the optional application of a bead of seam-sealing adhesive along the seam of the two adjacent pieces 110a, 110b of artificial turf.

In those exemplary embodiments of the present general inventive concept, specific components, materials, arrangements, and processes are used to describe the general inventive concept. Obvious changes, modifications, and substitutions may be made by those skilled in the art to achieve the same purpose of the general inventive concept. The exemplary embodiments are, of course, merely examples and are not intended to limit the scope of the general inventive concept. All embodiment s de scribed herein can be combined with each other. It is intended that the present general inventive concept includes all other embodiments that are with the scope of the disclosure and its equivalents.

What is claimed is:

1. A method for artificial turf installation comprising the steps of:
providing at least two artificial turf pieces, each having a backing including primary, secondary and tertiary materials, said tertiary material comprises a fabric for receiving a surface of a mechanical seaming tape;
placing a mechanical hook seaming tape on a surface to be covered by said artificial turf pieces;
positioning said at least two of said artificial turf pieces immediately adjacent to each other above said hook seaming tape; and
pressing said adjacent artificial turf pieces against said hook seaming tape.

2. The method as recited in claim 1 wherein said step of providing at least two artificial turf pieces having a backing includes the step of providing one of a woven fabric or a nonwoven fabric for said tertiary backing material.

3. The method as recited in claim 1 wherein said step of providing at least two artificial turf pieces includes the step of providing one of a cold urethane lamination or a hot melt lamination for said tertiary backing material.

4. The method as recited in claim 1 wherein said method comprises the step of providing a quick release membrane bonded to said hook seaming tape for easy removal.

5. The method as recited in claim 1 wherein said method comprises the step of applying an adhesive along a seam between said at least two artificial turf pieces.

6. The method as recited in claim 1 wherein said method comprises the step of providing an infill to be interspersed among filaments of said artificial turf.

7. A method for artificial turf installation comprising the steps of:
providing at least two artificial turf pieces, each having a backing including primary, secondary and tertiary materials, said tertiary material comprises a fabric for receiving a surface of a mechanical seaming tape;
placing a pressure-sensitive seaming tape on a surface to be covered by said artificial turf pieces;
positioning said at least two of said artificial turf pieces immediately adjacent to each other above said pressure-sensitive seaming tape; and
pressing said adjacent artificial turf pieces against said pressure-sensitive seaming tape.

8. The method as recited in claim 7 wherein said step of providing at least two artificial turf pieces having a backing includes the step of providing one of a woven fabric or a nonwoven fabric for said tertiary backing material.

9. The method as recited in claim 7 wherein said step of providing at least two artificial turf pieces includes the step of providing one of a cold urethane lamination or a hot melt lamination for said tertiary backing material.

10. The method as recited in claim 7 wherein said method comprises the step of providing a quick release membrane bonded to said hook seaming tape for easy removal.

11. The method as recited in claim 7 wherein said method comprises the step of applying an adhesive along a seam between said at least two artificial turf pieces.

12. The method as recited in claim 7 wherein said method comprises the step of providing an infill to be interspersed among filaments of said artificial turf.

13. An artificial turf installation comprising:
a mechanical hook seaming tape placed on a surface to be covered by artificial turf;
at least two artificial turf pieces, each having a backing including primary, secondary and tertiary materials, said tertiary material comprises a fabric for receiving a surface of said mechanical hook seaming tape; and
said at least two of said artificial turf pieces being positioned immediately adjacent to each other above said hook seaming tape for mechanically bonding said adjacent artificial turf pieces to said hook seaming tape.

14. The artificial turf installation as recited in claim 13 wherein said at least two artificial turf pieces comprises a backing which includes one of a woven fabric or a nonwoven fabric for said tertiary backing material.

15. The artificial turf installation as recited in claim 13 wherein said at least two artificial turf pieces includes one of a cold urethane lamination or a hot melt lamination for said tertiary backing material.

16. The artificial turf installation as recited in claim 13 wherein a quick release membrane is bonded to said hook seaming tape for easy removal.

17. The artificial turf installation as recited in claim 13 wherein said installation comprises an adhesive applied along a seam between said at least two artificial turf pieces.

18. The artificial turf installation as recited in claim 13 wherein said installation comprises an infill interspersed among filaments of said artificial turf.

19. An artificial turf installation comprising:
a pressure-sensitive seaming tape placed on a surface to be covered by artificial turf;
at least two artificial turf pieces, each having a backing including primary, secondary and tertiary materials, said tertiary material comprises a fabric for receiving a surface of said pressure-sensitive seaming tape; and
said at least two of said artificial turf pieces positioned immediately adjacent to each other above said pressure-sensitive seaming tape for mechanically bonding said adjacent artificial turf pieces to said pressure-sensitive seaming tape.

20. The artificial turf installation as recited in claim 19 wherein said at least two artificial turf pieces comprises a backing which includes one of a woven fabric or a nonwoven fabric for said tertiary backing material.

21. The artificial turf installation as recited in claim 19 wherein said at least two artificial turf pieces includes one of a cold urethane lamination or a hot melt lamination for said tertiary backing material.

22. The artificial turf installation as recited in claim 19 wherein a quick release membrane is bonded to said hook seaming tape for easy removal.

23. The artificial turf installation as recited in claim 19 wherein said installation comprises an adhesive applied along a seam between said at least two artificial turf pieces.

24. The artificial turf installation as recited in claim 19 wherein said installation comprises an infill interspersed among filaments of said artificial turf.
